(19) United States
(12) Patent Application Publication
(10) Pub. No.: US 2013/0209950 A2
(43) Pub. Date: Aug. 15, 2013

(54) OVEN FOR HEAT TREATMENT OF A MULTIPLICITY OF OBJECTS

(71) Applicant: Stefan Mohr, Hof (DE)

(72) Inventor: Stefan Mohr, Hof (DE)

(21) Appl. No.: 13/635,665

(22) PCT Filed: Mar. 25, 2011
(86) PCT No.: PCT/EP11/54655

§ 371 Date: Sep. 26, 2012

(51) Int. Cl. F27B 5/02; F27D 1/00; F27D 5/00; F27B 5/16; F27B 5/14

(52) U.S. Cl. 432/203; 432/201; 432/207; 432/253; 432/247

(57) ABSTRACT

The invention relates to an oven for heat treatment of a multiplicity of objects. The oven comprises a support stand, which is realized as a three-dimensional frame, an elongate heating chamber, which is arranged vertically or horizontally in a central region of the support stand, and a plurality of elongate combustion chambers, which are arranged vertically or horizontally inside the support stand. The oven additionally comprises a heating element, which is assigned to the heating chamber, and at least one fan for generating an air stream from the heating chamber to the combustion chambers. The combustion chambers are provided to receive the objects to be treated. The support stand is provided to support the heating chamber and the combustion chambers. The invention additionally relates to an oven installation having a multiplicity of such ovens.

### BACKGROUND OF THE INVENTION

1. Field of the Invention

The invention relates to an oven for heat treatment of a multiplicity of objects. Furthermore, the invention relates to an oven installation comprising a multiplicity of ovens.

2. Background and Relevant Art

There are numerous objects that must be subjected to heat treatment during their production. This also applies to the production of grinding disks. Thus, in the production of resin-based grinding disks, a heat treatment is required for hardening. For example, such grinding disks are produced with phenolic resin binding.

The heat treatment of grinding disks takes several hours, the grinding disks being heated up from, for example, 30° C. to over 200° C., and then cooled down again to approximately 30° C. Such a heat treatment results in a high energy consumption, since not only the grinding disks, but also the parts of the oven take up heat during heating. Owing to their high mass, the oven parts in the heated region of the oven have a high thermal capacity. During cooling, the energy stored in the oven parts is not used.

Known from GB 120,633 is an oven for heat treatment of objects that has a central heating chamber surrounded by a plurality of combustion chambers. Owing to the uptake of heat by the heating chamber and the combustion chambers, the energy consumption is relatively high.

DE 1 583 478 A1 describes an oven for heat treatment of grinding disks. The oven has a vertical combustion chamber, which is loaded from below. Owing to its structural design, this oven, likewise, has a relatively high energy consumption.

### BRIEF SUMMARY OF THE INVENTION

It is an object of the invention to provide an oven for heat treatment of a multiplicity of objects, whose structural design contributes to the saving of energy.

This object is achieved by the subject matter according to claim 1. Advantageous designs and developments of the invention are given by the dependent claims.

The oven according to the invention for heat treatment of a multiplicity of objects, in particular grinding disks, comprises:
a support stand, which is realized as a three-dimensional frame,
at least one, in particular elongate, heating chamber and
a plurality of, in particular elongate, heat treatment chambers, in particular combustion chambers,
at least one heating element, which is assigned to the heating chamber,
at least one fan for generating a gas stream, in particular air stream, from the heating chamber to the heat treatment chambers, wherein
the heat treatment chambers are provided to receive the objects, and
the support stand is provided to support the heating chamber and the heat treatment chambers.

The core of the invention consists in that, in the case of the oven, the supporting function is performed exclusively by the support stand. Consequently, the heating chamber and the heat treatment chambers can be realized with particularly thin walls. This results in the heating chamber and the heat treatment chambers having a low thermal capacity, such that, when in operation, the heating chamber and the heat treatment chambers take up relatively little heat, this resulting in a substantial saving of energy. The support stand is thermally decoupled from the heating chamber and from the heat treatment chambers. This results in a further substantial saving of energy, since thermal bridges that exist between the support stand, on the one hand, and the heating chamber and the heat treatment chambers, on the other hand, are greatly reduced. For this purpose, the heating chamber and the heat treatment chambers can be fastened to the support stand, at least indirectly, via a plurality of thermal insulating elements.

In a preferred embodiment, the support stand comprises at least one horizontal frame, preferably an upper horizontal frame and a lower horizontal frame, which in each case is composed of horizontal members, and vertical members, to which each horizontal frame or the horizontal members are connected, forming the three-dimensional frame. Each horizontal frame comprises at least three, preferably at least four horizontal members, and/or has a polygonal, in particular triangular or rectangular, outer contour. The horizontal members are generally connected at their ends to the vertical members.

The heating chamber is generally arranged vertically or horizontally in a central region of the support stand. The heat treatment chambers are also preferably-arranged vertically or horizontally inside the support stand, preferably distributed, in particular evenly distributed, around the heating chamber. Preferably, the heating chamber and the heat treatment chambers are arranged inside the space in the support stand that is encompassed by the horizontal frames and the vertical members, and/or the support stand constitutes a cage for the heating chamber and the heat treatment chambers.

The at least one heating element can be arranged inside the heating chamber and/or be connected in circuit before or after the heating chamber.

Alternatively or additionally, the heating element or elements can also be arranged in the heat treatment chambers or in the region of the covering hoods.

For example, the thermal insulating elements are made from a high-temperature insulating plastic.

Furthermore, it can be provided that the walls of the heating chamber and/or of the heat treatment chambers are provided, at least partially, with a thermal insulating material. As a result, release of heat from the heating chamber and the heat treatment chambers to the environment is prevented, or at least significantly reduced.

In particular, the heating chamber and the heat treatment chambers can be of a light construction, in particular made with flexible tube and/or with a wall thickness between 0.08 and 1 mm, preferably between 0.10 and 0.25 mm. The light construction results in a particularly low thermal capacity, and therefore in only a small amount of heat being taken up by the heating chamber and the heat treatment chambers. This results in a further substantial saving of energy.

In a further embodiment, a top plate is provided, on or in which the heating chamber and the heat treatment chambers are held in an upper region, in particular in that the walls of the heating chamber and of the heat treatment chambers are inserted with a precise fit in respective cutouts or through holes in the top plate. Further, preferably, a covering hood is provided, which tops or covers over the upper ends of the heating chamber and of the heat treatment chambers, which ends are open or provided with flow openings. Beneath the covering hood, in particular between the covering hood and the top plate, a cavity or flow space is provided for connecting, in respect of flow, the upper ends of the heating chamber and of the heat treatment chambers to each other for the purpose of routing the gas flow, which ends are open or provided with flow openings. The top plate and/or the covering hood are or is preferably fastened to a horizontal frame of the support stand, preferably to the upper horizontal frame, in particular are or is mounted or placed on the horizontal members thereof so as to be thermally decoupled via at least one interposed thermal insulating element in each case.

In a further embodiment, at least one base plate is provided, on or in which the heating chamber and the heat treatment chambers are held in a lower region.

The base plate is preferably fastened to a horizontal frame of the support stand, preferably to the lower horizontal frame, in particular is mounted or placed on the horizontal members thereof so as to be thermally decoupled via at least one interposed thermal insulating element in each case.

In a particular embodiment, the top plate and/or the base plate and/or the covering hood have or has a polygonal outer contour, in particular according to a polygon having more, preferably at least twice as many, corners than the polygon of the horizontal frame or frames, wherein a side of the base plate that is substantially parallel to the horizontal member lies on the horizontal member.

In the case of the preferred embodiment of the invention, the oven is provided for heat treatment of disk-shaped objects, in particular grinding disks. The grinding disks in this case are stacked in the heat treatment chambers. Preferably, the cross section of the heat treatment chambers is matched to the contour of the grinding disks.

In particular, it is provided that the oven has a multiplicity of arbors for stacking the disk-shaped objects. The arbors are arranged or can be introduced over each another in the vertical heat treatment chambers or next to each other in the horizontal heat treatment chambers. By means of the arbor, therefore, a defined quantity of grinding disks can be already assembled together outside the oven. The arbors, together with the grinding disks, can then be introduced in a “packet manner” into the heat treatment chambers of the oven.

Preferably, the arbors are of a light construction. As a result, the arbors likewise have a particularly low thermal capacity, and therefore take up little heat. This additionally contributes towards saving of energy.

For example, the heating element is arranged in an upper region of the vertical heating chamber. The heating element can equally be connected in circuit before or after the heating chamber.

For example, the heating element is realized as an electrical heating element. Basically, however, all kinds of heating are possible, such as steam, oil, gas, thermal oil carriers, etc.

Furthermore, the geometric form of the heat treatment chambers can be matched to the geometric form of the objects, such that the distance between the objects and the walls of the heat treatment chambers is uniform. In particular, the heating chamber and/or the heat treatment chambers have or has a tubular and/or cylindrical shape. At least one air duct, having a uniform cross section, can be realized in this case between the objects and the walls of the heat treatment chambers. As a result, fewer air masses have to be moved for the necessary heat exchange. The fan can be very small, this likewise resulting in a saving of energy.

Furthermore, the invention relates to an oven installation comprising a multiplicity of the ovens described above. The ovens in this case are arranged next to each other and interconnected to each other by means of warm air ducts and cold air ducts, such that a direct or indirect heat exchange is made possible between ovens that are cooling down and ovens that are heating up. This, likewise, is a substantial contribution to the saving of energy.

### BRIEF DESCRIPTION OF THE DRAWINGS

A preferred embodiment of the invention is explained more fully in the following with reference to the appended drawings. In a schematic representation in each case:

FIG. 1 shows a perspective view of an oven according to a preferred embodiment of the invention,

FIG. 2 shows a top view of the oven, with a covering hood removed, according to the preferred embodiment of the invention,

FIG. 3 shows a perspective detail view of a lower region of the oven according to the preferred embodiment of the invention,

FIG. 4 shows a front view of an oven installation having a plurality of ovens according to the preferred embodiment of the invention, and

FIG. 5 shows a top view of the oven installation having a plurality of ovens according to the preferred embodiment of the invention, and

FIG. 6 shows a perspective view of an arbor for the oven according to the preferred embodiment of the invention.

### DETAILED DESCRIPTION OF THE PREFERRED EMBODIMENTS

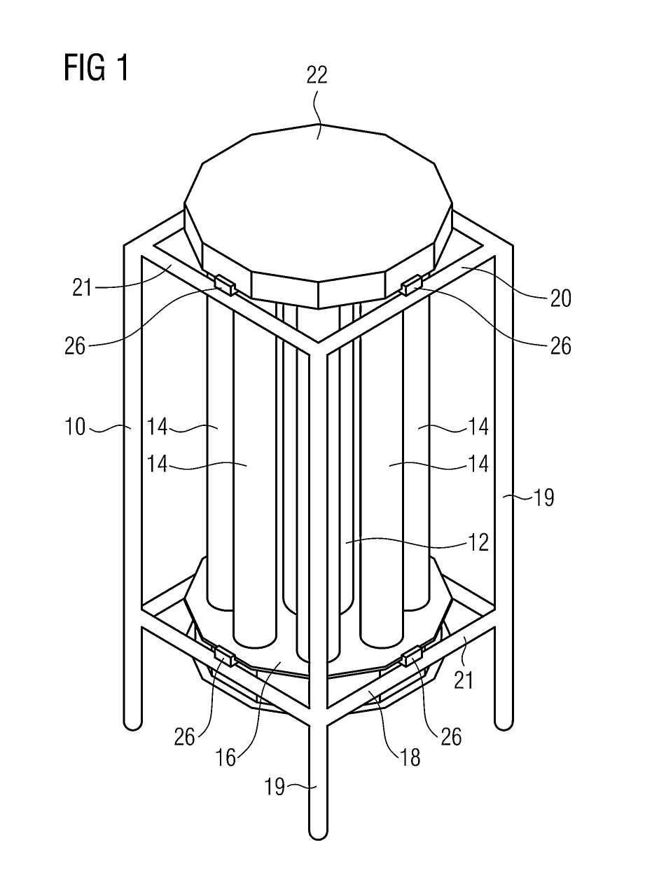

Represented in FIG. 1 is a perspective view of an oven according to a preferred embodiment of the invention. The oven is provided for heat treatment of a multiplicity of objects.

The oven comprises a support stand 10, which is realized as a three-dimensional frame having a plurality of members. A lower horizontal frame 18 and an upper horizontal frame 20 each comprise four horizontal members 21, which are fastened by their ends to four vertical members 19 or are connected to the latter in a square arrangement.

The oven additionally comprises a heating chamber 12, which is located inside the support stand 10, in the center thereof. The heating chamber 12 is elongate in form and arranged vertically. In this example, the heating chamber 12 has a round cross section.

Arranged around the heating chamber 12 there is a multiplicity of heat treatment chambers, in particular combustion chambers 14. The combustion chambers 14 are likewise elongate in form and arranged vertically. In this example, there are eight combustion chambers 14, evenly distributed around the heating chamber 12. The combustion chambers 14 also have a round cross section.

Located at the lower ends of the heating chamber 12 and of the combustion chambers 14 there is a base plate 16, on or in which the heating chamber 12 and the combustion chambers 14 are held in a lower region. The base plate 16 is fastened to a lower horizontal frame 18 of the support stand 10. Between the base plate 16 and the lower horizontal frame 18 there are thermal insulating elements 26.

The thermal insulating elements 26 are made from a material having a low thermal conductivity. The base plate 16 is thus thermally decoupled from the lower horizontal frame 18. Preferably, the thermal insulating elements 26 are made from a high-temperature insulating plastic.

The upper ends of the heating chamber 12 and of the combustion chambers 14 are open, or provided with flow openings. A common covering hood 22 tops or covers over the heating chamber 12 and all of the combustion chambers 14, or the upper ends thereof. The covering hood 22 is fastened to an upper horizontal frame 20 of the support stand 10. Between the covering hood 22 and the upper horizontal frame 20 there are likewise thermal insulating elements 26, such that the covering hood 22 is thermally decoupled from the upper horizontal frame 20.

The upper ends of the heating chamber 12 and of the combustion chambers 14 are connected to each other, in respect of flow, via a cavity under the covering hood 22. In the heating chamber 12 there is a heating element 28. In this embodiment, this is an electrical heating element, which is arranged in the upper region of the heating chamber 12. The combustion chambers 14 are provided to receive the multiplicity of objects subjected to heat treatment.

Arranged beneath the base plate 16 there is a fan 24. In this example, this is a radial fan, the rotational axis of which is arranged vertically. The air heated by the heating element 28 is conveyed out of the heating chamber 12 by the fan 24, such that the air in the heating chamber 12 moves from the top downward. The heated air is then blown by the fan 24 into the combustion chambers 14, such that the air in the combustion chambers 14 moves from the bottom upward. The heat treatment of the objects is effected in the combustion chambers 14. Under the covering hood 22, the air from the upper combustion chambers 14 goes back into the heating chamber 12.

The support stand 10 constitutes the supporting part of the oven, and preferably is substantially in the shape of a cage that surrounds or encloses the heating chamber 12 and the combustion chambers 14, and preferably also the covering hood 22. Consequently, the heating chamber 12, the combustion chambers 14 and the covering hood 22 can be of a light construction, since they do not need to have any supporting functions. The light construction renders possible a lower thermal capacity, such that the heating chamber 12, the combustion chambers 14 and the covering hood 22 take up only a small amount of heat. In this example, the heating chamber 12 and the combustion chambers 14 are made from a special flexible tube, which has a wall thickness of 0.13 mm. This is possible, since the heating chamber 12 and the combustion chambers 14 do not have any supporting function.

In addition, the support stand 10, together with the lower horizontal frame 18, is thermally decoupled from the heating chamber 12, the combustion chambers 14, the base plate 16 and the covering hood 22, because of the thermal insulating elements 26, such that the support stand 10, together with the lower horizontal frame 18, does not take up any heat, or takes up only a small amount of heat. This results in a significant saving of energy.

In the case of this specific embodiment, the oven is provided for heat treatment of resin-based grinding disks. For example, the grinding disks are made with phenolic resin. The heat treatment causes the grinding disks to be hardened. The round grinding disks in this case are stacked in the combustion chambers 14, which have a round cross section. The cross section of the combustion chambers 14 is thus matched to the shape of the grinding disks to be treated.

Finally, the heating chamber 12 and the combustion chambers 14 are clad with an insulating material. The insulating material is made, for example, from mineral wool or glass wool, and laminated on to the outside together with an aluminum foil. In the case of this embodiment, the insulating material has a thickness of 100 mm to 150 mm. This, likewise, contributes to a saving of energy.

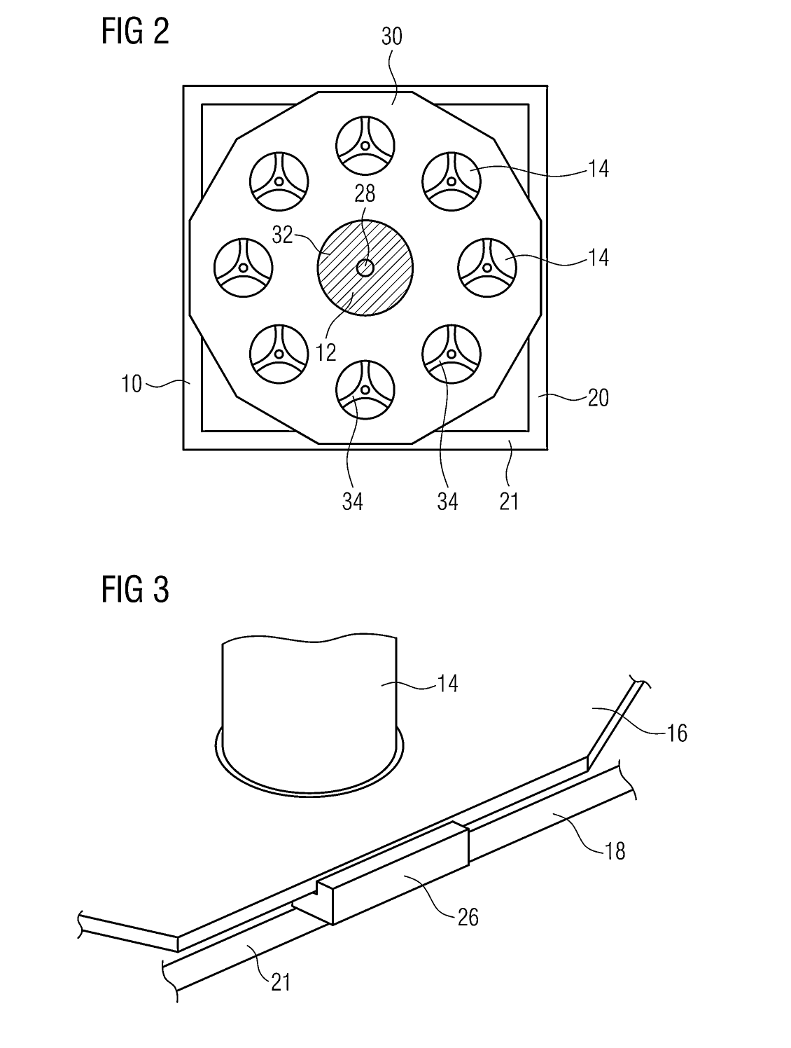

FIG. 2 shows a top view of the oven, with a covering hood 22 removed, according to the preferred embodiment of the invention. At the upper ends of the heating chamber 12 and of the combustion chambers 14 there is a top plate 30, on or in which the heating chamber 12 and the combustion chambers 14 are held, for example in that the walls of the heating chamber 12 and of the combustion chambers 14 are inserted with a precise fit in respective cutouts or through holes in the top plate 30. The top plate 30, just like the covering hood 22, is fastened to the upper horizontal frame 20 of the support stand 10 by means of the thermal insulating elements 26. The top plate 30 is thus also thermally decoupled from the support stand 10. In particular, the top plate 30, in its outer contour, matches or is in alignment with the outer contour of the covering hood 22. The top plate 30 and the covering hood 22 thus constitute an upper housing, which surrounds or encloses a cavity.

The electrical heating element 28 is suspended in the upper region of the heating chamber 12. The heating element 28 can be demounted in an unelaborate manner for servicing and repair purposes. At its upper end, the heating chamber 12 has a protective grid 32 for the heating element 28. At their upper ends, the combustion chambers 14 each have a centering element 34 for central positioning of the grinding disks.

Represented in FIG. 3 is a perspective detail view of a lower region of the oven according to the preferred embodiment of the invention. FIG. 3 shows, in particular, the thermal decoupling between the support stand 10, on the one hand, and the heating chamber 12 and the combustion chambers 14, on the other hand. The detail view shows, in particular, the thermal insulating element 26, which is arranged between the base plate 16 and the lower horizontal frame 18. The thermal insulating element 26 is realized as an L profile section. The thermal insulating element 26 is made from the high-temperature insulating plastic. Also shown is the lower end of a combustion chamber 14.

The base plate 16 and the top plate 30 each have a polygonal outer contour, in particular according to a polygon having more, preferably at least twice as many, corners than the polygon of the horizontal frame or frames, wherein a side of the base plate that is substantially parallel to the horizontal member lies on the horizontal member.

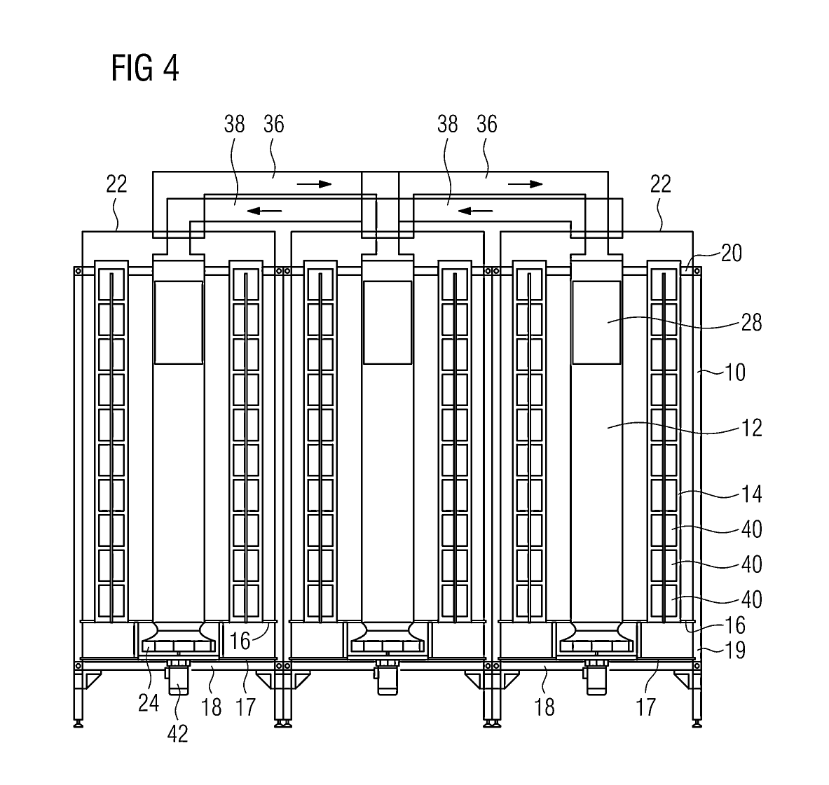

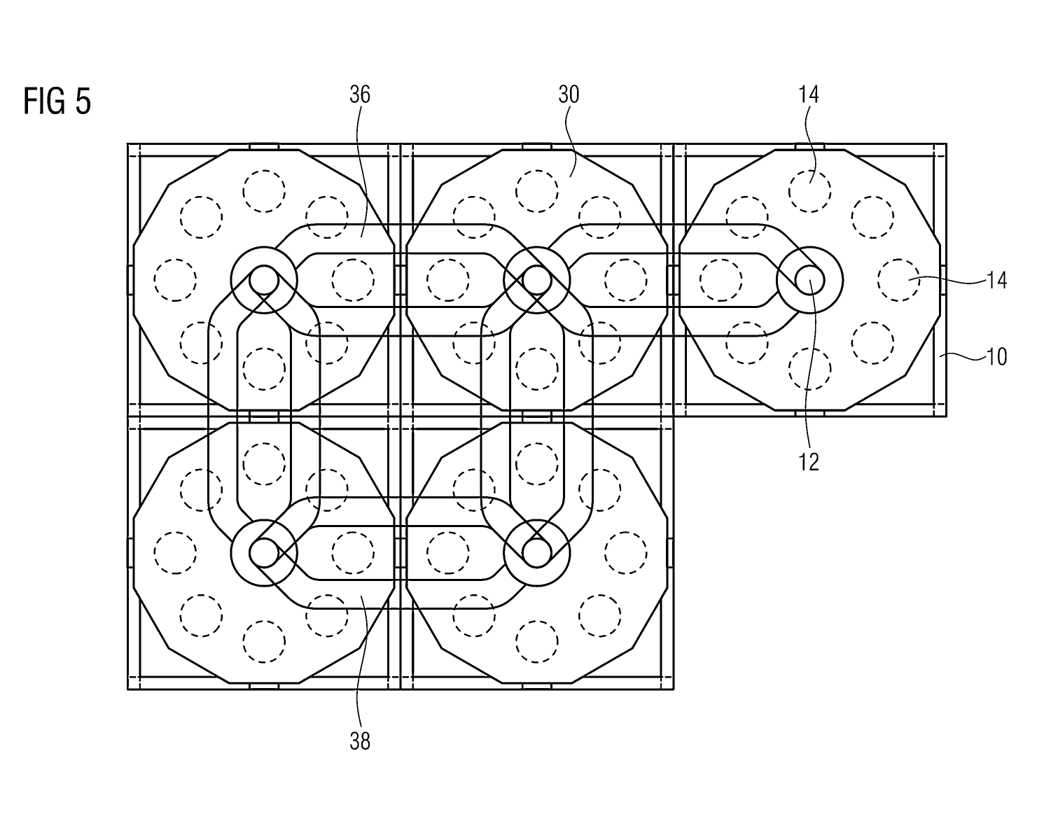

FIG. 4 shows a front view of an oven installation having a plurality of ovens according to the preferred embodiment of the invention. In the case of the oven installation, the ovens are arranged next to each other.

The arrangement of the heating element 28 in the upper region of the heating chamber 12 can be seen in FIG. 4. The grinding disks are arranged inside the combustion chambers 14. A certain number of grinding disks are first stacked on an arbor 40. A plurality of such arbors 40 are inserted into the combustion chambers 14 from below. In this example, ten arbors 40 are provided per combustion chamber 14.

In addition, FIG. 4 illustrates the arrangement of the fan 24. A motor 42 for driving the fan 24 is located beneath the fan 24.

In the case of the oven installation, the adjacent ovens are interconnected to each other by means of a warm air duct 36 and a cold air duct 38. In this case, warm air is conveyed out of an oven that is just in the process of cooling down, into an oven that is just in the process of heating up. This, likewise, contributes to a saving of energy.

The ovens in FIG. 4 are arranged next to each other, the rectangular support stands 10 being placed against each other with a precise fit or substantially without separation, and being fastened to each other, at least in a lower region. Located on the lower horizontal frame 18 there is a further base plate 17, which, again, is preferably thermally insulated by means of insulating elements, and on which the fan 24 and its housing are fastened.

FIG. 5 shows a top view of the oven installation having a plurality of ovens according to the preferred embodiment of the invention. In this example, the oven installation comprises five ovens. FIG. 5 illustrates, in particular, the arrangement of the warm air ducts 36 and the cold air ducts 38.

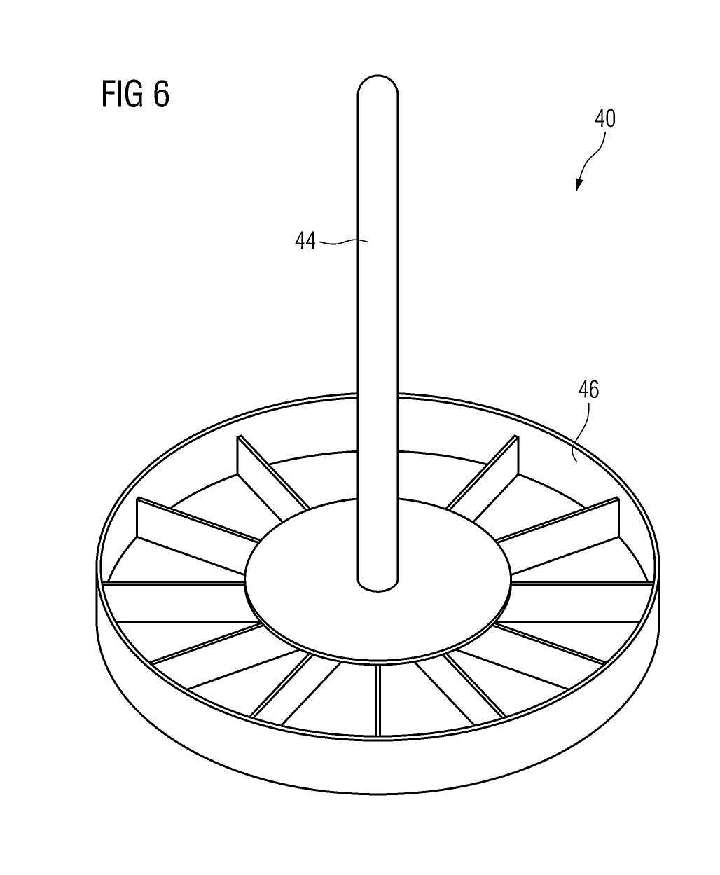

Represented in FIG. 6 is a perspective view of an arbor 40 for the oven according to the preferred embodiment of the invention. The arbor 40 is provided for stacking a defined quantity of grinding disks.

The arbor 40 comprises a vertical tube 44 and a round base part 46. The base part 46 is composed of an outer ring and a plurality of spokes. The arbor 40 is thus also of a light construction. The thermal capacity of the arbor 40 is therefore low. During heating up, the arbor 40 takes up only a small amount of heat, such that this, likewise, contributes to a saving of energy.

The centering elements 34 represented in FIG. 2 are provided for centrally positioning the arbors 40 inside the combustion chambers 14.

### LIST OF REFERENCES

10 support stand
12 heating chamber
14 combustion chamber
16 base plate
17 base plate
18 lower horizontal frame
19 vertical member
20 upper horizontal frame
21 horizontal member
22 covering hood
24 fan
26 thermal insulating element
28 heating element
30 top plate
32 protective grid
34 centering element
36 warm air duct
38 cold air duct
40 arbor
42 motor
44 tube
46 base part

We claim:

1-11. (canceled)

12. An oven for heat treatment of a multiplicity of objects, in particular grinding disks, which comprises the following:
a support stand, which is realized as a three-dimensional frame;
at least one, in particular elongate, heating chamber; and
a plurality of, in particular elongate, heat treatment chambers, in particular combustion chambers;
at least one heating element, which is assigned to the heating chamber;
at least one fan for generating a gas stream, in particular air stream, from the heating chamber to the heat treatment chambers,
wherein:
the heat treatment chambers are provided to receive the objects,
the support stand is provided to support the heating chamber and the heat treatment chambers;
the support stand is thermally decoupled from the heating chamber and from the heat treatment chambers; and
the heating chamber and the heat treatment chambers are fastened to the support stand, at least indirectly, via a plurality of thermal insulating elements.

13. The oven as claimed in claim 12, having at least one or any combination of the following features:
a) the support stand comprises at least one horizontal frame, preferably an upper horizontal frame and a lower horizontal frame, which in each case is composed of horizontal members, and vertical members, to which each horizontal frame or the horizontal members are connected, forming the three-dimensional frame;
b) each horizontal frame comprises at least three, preferably at least four horizontal members;
c) each horizontal frame has a polygonal, in particular triangular or rectangular, outer contour; or
d) the horizontal members are connected at their ends to the vertical members.

14. The oven as claimed in claim 12, having at least one or any combination of the following features:
a) the heating chamber is arranged vertically or horizontally in a central region of the support stand;
b) the heat treatment chambers are arranged vertically or horizontally inside the support stand;
c) the heating chamber and the heat treatment chambers are arranged inside the space in the support stand that is encompassed by the horizontal frames and the vertical members;
d) the support stand constitutes a cage for the heating chamber and the heat treatment chambers.

15. The oven as claimed in claim 12, having at least one or any combination of the following features:
a) the thermal insulating elements are made from a high-temperature insulating plastic; and
b) the walls of the heating chamber and/or of the heat treatment chambers (14) are provided, at least partially, with a thermal insulating material.

16. The oven as claimed in claim 12, having at least one or any combination of the following features:
a) a top plate is provided, on or in which the heating chamber and the heat treatment chambers are held in an upper region, in particular in that the walls of the heating chamber (and of the heat treatment chambers are inserted with a precise fit in respective cutouts or through holes in the top plate;
b) a covering hood is provided, which tops or covers over the upper ends of the heating chamber and of the heat treatment chambers, which ends are open or provided with flow openings;
c) beneath the covering hood, in particular between the covering hood and the top plate, a cavity is provided for connecting, in respect of flow, the upper ends of the heating chamber and of the heat treatment chambers to each other for the purpose of routing the gas flow, which ends are open or provided with flow openings;
d) the top plate and/or the covering hood are or is fastened to a horizontal frame of the support stand, preferably to the upper horizontal frame, in particular are or is mounted or placed on the horizontal members thereof so as to be thermally decoupled via at least one interposed thermal insulating element in each case;
e) the top plate and/or the covering hood have or has a polygonal outer contour, in particular according to a polygon having more, preferably at least twice as many, corners than the polygon of the horizontal frame or frames, wherein a side of the top plate and/or covering hood that is substantially parallel to the horizontal member lies on the horizontal member.

17. The oven as claimed in claim 12, having at least one or any combination of the following features:
a) at least one base plate is provided, on or in which the heating chamber and the heat treatment chambers are held in a lower region;
b) the base plate is fastened to a horizontal frame of the support stand, preferably to the lower horizontal frame, in particular is mounted or placed on the horizontal members thereof so as to be thermally decoupled via at least one interposed thermal insulating element in each case;
c) the base plate has a polygonal outer contour, in particular according to a polygon having more, preferably at least twice as many, corners than the polygon of the horizontal frame or frames, wherein a side of the base plate that is substantially parallel to the horizontal member lies on the horizontal member.

18. The oven as claimed in claim 12, having at least one or any combination of the following features:
a) the heating chamber and the heat treatment chambers are of a light construction, in particular are made with flexible tube and/or with a wall thickness between 0.08 and 1 mm, preferably 0.10 and 0.25 mm, such that the thermal capacities of the heating chamber and of the heat treatment chambers are relatively low;
b) the oven is provided for heat treatment of disk-shaped objects, in particular grinding disks;
c) the heating chamber and/or the heat treatment chambers have or has a tubular and/or cylindrical shape;
d) the heat treatment chambers are arranged, in particular are evenly distributed, around the heating chamber.

19. The oven as claimed in claim 12, further comprising:
a) a multiplicity of arbors for stacking the objects, in particular disk-shaped objects, wherein the arbors are arranged or can be introduced, over each another, in or into the heat treatment chambers;
b) wherein the arbors are preferably of a light construction.

20. The oven as claimed in claim 12, having at least one or any combination of the following features:
a) the at least one heating element is arranged inside the heating chamber;
b) the at least one heating element is connected in circuit before or after the heating chamber;
c) the at least one heating element can be supplied with electric current, oil, gas, steam and/or thermal oil carrier.

21. The oven as claimed in claim 12, having at least one or any combination of the following features:
a) the geometric form of the heat treatment chambers is matched to the geometric form of the objects, such that the distance between the objects and the walls of the heat treatment chambers is uniform;
b) at least one flow duct or gas duct or air duct having a uniform cross section is realized between the objects and the walls of the heat treatment chambers.

22. An oven installation having a multiplicity of ovens as claimed in claim 12, wherein:
the ovens are arranged next to each other and are interconnected to each other by means of warm air ducts and cold air ducts, such that a heat exchange is made possible between ovens that are cooling down and ovens that are heating up.
